(19) United States
(12) Patent Application Publication
(10) Pub. No.: US 2025/0353187 A1
(43) Pub. Date: Nov. 20, 2025

(54) Construction Robot With Parallel Manipulator

(71) Applicant: Hilti Aktiengesellschaft, Schaan (LI)

(72) Inventors: Nitish KUMAR, Buchs (CH); Sascha KORL, Buchs (CH); Christian LANEGGER, Zuerich (CH); Marco RUGGIA, Chur (CH); Marco TOGNON, Zuerich (CH); Lionel OTT, Zuerich (CH); Roland SIEGWART, Schwyz (CH); Peter BRUGGER, Feldkrich (AT); Julia ZANONA, Feldkrich (AT)

(21) Appl. No.: 18/866,926

(22) PCT Filed: May 9, 2023
(86) PCT No.: PCT/EP2023/062170

§ 371 Date: Nov. 18, 2024

(30) Foreign Application Priority Data
May 19, 2022 (EP) 22174203.4

(51) Int. Cl. B25J 11/00; B25J 9/16; B25J 13/08; B25J 15/02; B25J 19/02; B64U 10/14

(52) U.S. Cl. CPC B25J 11/005; B25J 9/162; B25J 13/089; B25J 15/0253; B25J 19/023; B64U 10/14

(57) ABSTRACT

A construction robot for carrying out construction work on a construction site object includes a mobile platform, an end effector, where the end effector has a tool or a tool fitting and where the end effector has a contact element which is configured to contact the construction site object, a parallel manipulator, where the end effector and the mobile platform are connected to one another via the parallel manipulator, and a sensor system, where a pose of the end effector relative to the mobile platform is detectable by the sensor system.

### BACKGROUND AND SUMMARY OF THE INVENTION

The invention relates to a construction robot for carrying out construction work on a construction site object, comprising a mobile platform and an end effector, wherein the end effector has at least one tool and/or a tool fitting for receiving a tool.

It is often necessary for construction work on construction sites to be carried out with highly accurate positioning. For example, bores on ceilings must often be produced with positional accuracy of 0.5 cm or better, so that for example ceiling elements to be arranged on the ceiling can be correctly fixed to the bores. If such drilling work is to be carried out with a construction robot, very high demands have had to be made until now, in particular on the achievable positional accuracy of the mobile platform of the construction robot. In particular, it has not been possible until now to achieve the required positioning accuracies with any type of mobile platform. Mobile platforms that could be used until now are severely limited in their movement options and/or very costly to manufacture. Furthermore, it is particularly desirable if construction work can be carried out with such positioning accuracies even in places that are difficult to reach, such as on high ceilings.

The object of the present invention is therefore to offer a low-cost construction robot which can carry out construction work with a particularly high degree of positional accuracy. Positional accuracies of 0.5 cm or less are particularly desirable.

The object is achieved by a construction robot for carrying out construction work on a construction site object, the robot comprising a mobile platform, an end effector, wherein the end effector has at least one tool or a tool fitting for receiving a tool, and a parallel manipulator, wherein the end effector and the mobile platform are connected to one another via the parallel manipulator, and wherein the end effector has at least one contact element which is configured to contact the construction site object to be worked on during construction work, and a sensor system for detecting a pose of the end effector relative to the mobile platform.

Via the parallel manipulator, the mobile platform and the end effector may thus be connected to one another, in particular movably relative to each other. The contact element may then be used to fix the position of the end effector relative to the construction site object, for example a ceiling or wall to be worked on, at least for a short time. Effects of vibrations or other, in particular minor, changes in the position of the mobile platform on the position of the end effector can be reduced. The positional accuracy with which a position reached by the end effector is assumed and/or maintained can thus be particularly high. The sensor system may further increase this positional accuracy by precisely detecting relative movements between the mobile platform and the end effector and, if necessary, initiating corrective measures. External influences, such as impulse shocks acting on the mobile platform, for example caused by gusts of wind, may act selectively on the mobile platform due to the contact of the end effector via the contact element with the construction site element and may thus lead to a relative displacement of the latter relative to the end effector. This offset can be detected by the sensor system. If necessary, the parallel manipulator may then be counter-controlled to execute a corrective movement.

A tool may be an insertion tool such as for example a marking tool, drill, a chisel, a saw blade or a grinding tool. Alternatively or additionally, a tool may be a power tool, in particular configured for receiving and/or using a tool, for example a marking machine, for example a controllable paint spray nozzle, a power drill, a power chisel, a power grinder or similar.

A pose of an object can be understood as a position and/or an attitude, i.e., an orientation, of the object.

The sensor system can detect the pose indirectly. For example, it can be based on position sensors for detecting positions of the arms of the parallel manipulator and can infer the pose from the data obtained from these.

Particularly preferably, the sensor system can detect the pose directly, in particular by determining at least one position and/or attitude of a point on the end effector relative to the mobile platform. Such a direct measurement may make it unnecessary to compare the measured values of the sensor system with the actual movements of the parallel manipulator, which may otherwise be necessary.

The sensor system may be designed to work mechanically. For example, it may mechanically detect a position of an element of the parallel manipulator, in particular relative to the mobile platform.

Alternatively or additionally, it is also conceivable that the sensor system operates on an optical basis.

The sensor system may for example comprise a laser distance meter. Alternatively or additionally, it may comprise at least one image recording unit. For example, the image recording unit may comprise a black-white and/or color image camera.

Accordingly, it may be arranged on the mobile platform and/or on the end effector.

A location marking may be arranged and/or formed on the end effector and/or on the parallel manipulator and/or generally on a part opposite the sensor system. The location marking may comprise, for example, an AruCo marking or the like.

In particular, a sensor system operating on an optical basis can detect the pose without contact and at high frequency, especially with high accuracy. Such a sensor system may also have a low weight.

In order to allow continuous monitoring of the pose, the location marking may be at least partly, preferably completely, arranged in a field of view of the image recording unit.

The construction robot may also have an acceleration sensor. The acceleration sensor may be formed in particular on the end effector. The acceleration sensor may be configured to detect accelerations in at least one direction, preferably two dimensions, in particular preferably three dimensions.

Changes in the pose detected by the sensor system and/or the acceleration sensor may be able to be compensated by an adjustment device of the construction robot. The adjustment device may be formed on the contact element. Alternatively or additionally, the adjustment device may form the contact element.

In particular, it is conceivable that the adjustment device is formed by the parallel manipulator.

To perform the construction work, the tool may contact the construction site object to be machined. The contact element may then contact the construction site object in addition to the tool.

Manufacturing costs can be reduced and production simplified if the parallel manipulator is formed as a passive system.

The parallel manipulator may in particular be formed as a hexapod. Alternatively, it is also conceivable that it may be formed as a tripod, also sometimes referred to as a delta manipulator.

The parallel manipulator may generally have at least three, particularly preferably at least six, degrees of freedom, in particular relative to the mobile platform. At least three degrees of freedom allow working on ceilings or walls without pivoting the mobile platform from the vertical into the horizontal or vice versa. With six degrees of freedom, work can be carried out both on the ceiling and on the walls without pivoting the mobile platform. Also, construction work can be carried out at positions otherwise difficult to reach, e.g., if otherwise, with fewer degrees of freedom, installation elements such as lines or cable guides would block the way to the desired position.

The end effector may also offer further degrees of freedom. For example, a telescopic element may be arranged on the end effector, by means of which for example the tool can be moved relative to the end effector.

For construction work on ceilings, the end effector is arranged on top of the parallel manipulator. The parallel manipulator should therefore be designed to provide stable support for the end effector from below during such construction work. Accordingly, it is favorable if the arms of the parallel manipulator are arranged in such a way that such a stable support results.

It is therefore favorable if the parallel manipulator is designed in such a way that, if the end effector deflects slightly out of a rest position relative to the mobile platform, it automatically returns to the rest position, in particular driven by gravity.

A possible arrangement of the arms for this purpose can be determined by drawing up an energy balance of the system, in particular taking into account potential, kinetic and possibly mechanical energy, for example energy stored in spring elements, and a subsequent search for a local, or preferably a global, energy minimum.

Construction work at great heights, in particular on ceilings, may be possible if the mobile platform is a flying platform. Flying platforms often have low original positional accuracies, and are often also exposed to external influences, such as gusts of wind. By taking the above measures, an end effector can be guided with the required positional accuracy despite such low original positional accuracy. The construction work can thus be carried out with the required quality. The flying platform may be a drone. It may have at least one propeller. Flying may then also include hovering. The mobile platform may be designed for cable-connected and/or cable-free performance of construction work. For example, it may be connected to a supply line during a flight. Alternatively or additionally, it may also comprise an accumulator, in particular lithium-based. It is also conceivable for the flying platform to have a fuel cell. Alternatively or additionally, it is also conceivable that the mobile platform comprises and/or is configured as a travelling platform. To extend its reach in the vertical, in particular when configured as a travelling platform, the mobile platform may have a lifting device.

The construction robot, in particular the end effector, may have a laser distance meter. In this case, at least one position marking may be arranged on the construction site so that a pose of the construction robot relative to the position marking, preferably to multiple position markings, can be determined. Alternatively or additionally, it may be configured to be detected by a total station so that its position and/or attitude can be determined. For this, the construction robot may for example have a reflector, e.g., in the form of a prism. Thus a pose of the construction robot can be determined, in particular a position and/or an attitude relative to an absolute reference system of the construction site and/or the total station or the at least one position marking.

Due to occlusions, working positions at which the construction work is to be carried out and to which the tool or at least a tip of the tool is therefore to be brought are often not in the field of view of the total station or, therefore, the reflector or the laser distance meter may be arranged on the mobile platform, to which a visual connection often can be created. Thus then at least one pose of the mobile platform can be detected, and in addition, with knowledge of the relative offset of the mobile platform to the end effector, in particular to the tip of the tool, a pose of the end effector, in particular a pose of the tip of the tool, can also be determined.

If there are several, in particular at least three, contact elements, the end effector can be stabilized in several directions relative to the working point or the ceiling. For example, three-point stabilization can be achieved.

The contact element may have at least one wheel, in particular an omnidirectional wheel.

Particularly preferably, the contact element, in particular the wheel, can be driveable. In general, the contact element can be movable and/or adjustable by motor. This allows the pose of the contact element to be matched to the substrate to be contacted.

Also, a pose of the end effector, in particular the tool, relative to the working point where the construction work is to be performed may thus be finely adjusted by suitably moving the contact element, in particular the wheel. In particular, the contact element may thus form the adjustment device or at least part of the adjustment device. The pose may thus additionally be adjusted at least two-dimensionally as soon as the construction robot contacts the working point, for example the ceiling, with its contact element.

The parallel manipulator may have at least one reset element and/or a damping element. Vibrations or slight movements of the mobile platform may thus be damped. The end effector and in particular the tool may thus be further stabilized relative to the mobile platform. The reset element and/or the damping element may have a spring element.

The construction robot may be designed to perform marking work. For example, it may be designed to transfer CAD data, for example in the form of Building Information Model (BIM) data, to the construction site. Here, a particular positional accuracy, in particular of no more than 5 mm, is particularly advantageous.

For this purpose, the marking tool may be and/or comprise the tool. The tool may, for example, have a pen, a spraying device, an adhesive device, in particular for gluing on markings, or an engraving device.

Alternatively or additionally, the tool may be and/or comprise a drilling tool, a chiselling tool, a grinding tool or a cutting tool, in particular a saw blade. Accordingly, the construction robot may be designed to drill, chisel and/or cut.

The tool may be arranged on a lifting device. Thus, the tool may be moved towards or away from the working point to be processed. In the case of a marking tool formed as a pin and the marking of positions on a ceiling, the pin may thus be placed on the ceiling at a position to be marked and removed from it again if required.

The end effector may have an x-y drive. The x-y drive may be configured to move the tool and/or the lifting device two-dimensionally relative to the end effector. Thus, for example, in the case of the tool formed as a marking tool, smaller structures of a marking, for example a character to be written on the ceiling, can be transferred to the ceiling without having to move the end effector.

The end effector may be formed as an independent platform so that it can be combined with different types of mobile platforms.

The end effector, in particular together with the parallel manipulator and/or one or more of the features mentioned in conjunction with the end effector, may also be understood as an invention in itself.

The present scope also includes a calibration-free construction robot comprising a mobile platform and a manipulator movable relative to the mobile platform. The construction robot may have a sensor system, in particular optical sensor system, which is arranged and/or formed at least partially on the mobile platform and which is designed to determine a position and/or an attitude of the manipulator, in particular of a tool arranged on the manipulator, relative to the mobile platform. Part of the sensor system may be arranged and/or formed on the manipulator. The sensor system may comprise a camera and a location marking. Preferably, the location marking is arranged in the field of view of the camera.

The manipulator may have, for example, a multi-axis arm. It may alternatively or additionally, in particular analogously to the aforementioned, be a parallel manipulator and/or comprise such a manipulator.

One advantage of the calibration-free construction robot is that this can determine a position and/or attitude of the end effector, in particular the tool, relative to the mobile platform autonomously and independently of mechanical properties of the manipulator. So if the manipulator is replaced, it does not require calibration, or in any case fewer calibration measures, in order to control the tool with the replacement manipulator precisely at desired positions. Rather, the manipulator can be moved and the reached position of the end effector and/or tool relative to the mobile platform determined using the sensor system, for example in a feedback loop. If the reached position deviates from the nominal position, a correction movement of the manipulator may take place repeatedly until the nominal position is reached.

The calibration-free robot may also have one or more features of a construction robot described above and/or below.

Furthermore, the present framework also includes a use of a sensor system, in particular an optical sensor system, together with a construction robot comprising a mobile platform and a manipulator, wherein a position and/or attitude of the manipulator and/or of a tool arranged on the manipulator relative to the mobile platform is determined with the aid of the sensor system.

Also in the context of use, the sensor system and/or the construction robot may have one or more of the features of a construction robot or sensor system described above and/or below.

Further features and advantages of the invention are apparent from the detailed description of exemplary embodiments of the invention that follows, with reference to the figures of the drawings which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawings and elucidated in detail in the description that follows.

### BRIEF DESCRIPTION OF THE DRAWINGS

FIG. 1 shows a construction robot which carries out a construction task on a ceiling;

FIG. 2 shows an end effector platform of the construction robot; and

FIG. 3 shows a location marking.

### DETAILED DESCRIPTION OF THE DRAWINGS

In the description of the figures that follows, comprehension of the invention is facilitated by use of the same reference signs in each case for identical or functionally corresponding elements.

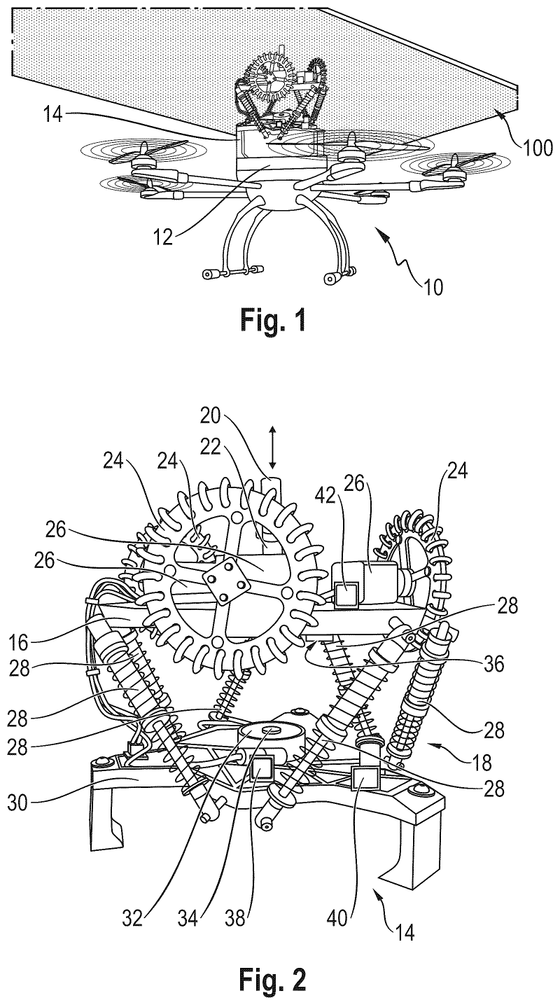

FIG. 1 shows a construction robot 10 which carries out a construction task on a ceiling 100, i.e., a construction site object, of a building in construction, in particular on a construction site inside the building. The construction task consists of creating markings corresponding to existing CAD plan data on the underside of the ceiling 100.

The construction robot 10 is configured as a drone, i.e., an unmanned flying object. For this, it has a mobile platform 12 in the form of a hexacopter. An end effector platform 14 is arranged on the mobile platform 12.

FIG. 2 shows the end effector platform 14 in a perspective view from the side.

The end effector platform 14 comprises an end effector 16. The end effector 16 is connected to the mobile platform 12 via a parallel manipulator 18 of the construction robot 10.

The construction robot 10 is configured to create markings on the ceiling 100 according to the CAD data transmitted to the construction robot 10. For this, the end effector 16 has a marker pen 20.

The marker pen 20 is arranged on a lifting device 22. Thus in the situation of the construction robot 10 shown in FIG. 1, the marker pen 20 can be moved towards and/or away from the ceiling 100, in particular without the end effector platform 14 as a whole having to be moved. This movement possibility is symbolized in FIG. 2 by a double arrow.

The marker pen 20 is configured as a colored pen so that it can apply a colored marking to the ceiling 100 as soon as it touches the ceiling 100. In order to allow an adequate color application and protect the marker pen 20 from excessive mechanical loads, the marker pen 20 may be arranged on the lifting device 22 in sprung fashion, e.g., by means of a foam material and/or a metal element. The marker pen 20 thus constitutes a marking tool which is received in a tool fitting (not visible in the illustration of FIG. 2) which in turn is arranged on the lifting device 22.

The end effector 16 furthermore has three contact elements 24. The contact elements 24 are configured as wheels, in particular as omnidirectional wheels. As evident in particular also from FIG. 1, during performance of the construction task, i.e., during marking of the ceiling 100, the contact elements 24 contact the ceiling 100. They can be driven individually by motors 26. Thus by means of the motorized contact elements 24, i.e., in this exemplary embodiment by means of the omnidirectional wheels, the end effector 16 can move along the ceiling 100 (FIG. 1) in at least two dimensions.

The parallel manipulator 18 is formed as a hexapod. It has six support arms 28. In this exemplary embodiment, the support arms 28 are not driven but are rotatably mounted on bearing points of the end effector 16 firstly and on bearing points of a fastening device 30 below the end effector 16. Thus the end effector 16 is movable relative to the fastening device 30, in particular with at least six degrees of freedom, but remains supported by the support arms 28. The manipulator 18 is thus formed as a passive system.

The support arms 28 are configured as in particular fluid-damped shock absorbers. For damping, they have a fluid-filled, in particular water-filled piston, and spring elements arranged on the outside. The pistons together with the respective spring element thus form damping elements. In addition, on deflection of the end effector 16 relative to the fastening device 30 out of a rest position, the spring elements ensure automatic return to the rest position. The spring constant of the support arms 28 may be set such that in the rest position, they are retracted to around half the total length of the support arms 28 under the weight of the end effector 16 or alternatively the own weight of the end effector 16 plus an additional load force to be expected, e.g., 15 N. They may be configured such that, starting from the rest position, the end effector 16 can be moved sufficiently far, for example by 2 to 4 cm in the X and Y directions of a plane parallel to the end effector 16.

The support arms 28 are arranged such that in the rest position, the end effector platform 14 is in a stable state. In particular, the support arms 28 are arranged such that the end effector 16 does not autonomously tilt towards one side.

Suitable positions and/or attitudes for the support arms 28, for ensuring such a stable rest position, are found if a total energy balance of the arrangement is produced, in particular comprising an attitude energy of the end effector and in some cases the support arms 28 depending on their position and/or attitude, and a clamping energy of the spring elements of the support arms 28, and a global minimum, at least however a local minimum, of the total energy is sought depending on the positioning and alignment of the support arms 28.

The fastening device 30 is used to fasten the end effector platform 14 to the mobile platform 12 (see FIG. 1). The fastening may be releasable so that the end effector platform 14 can also later be mounted on other mobile platforms, e.g., octacopters, or on another ground-supported mobile platform, e.g., a wheeled and/or tracked vehicle.

The fastening device 30 forms a lower level below the end effector 16. It has lighting 32 and a camera 34. The lighting 32 and the camera 34 are oriented upward, i.e., towards the underside of the end effector 16. A location marking 36 is situated on the underside of the end effector 16, in particular in the field of view of the camera 34.

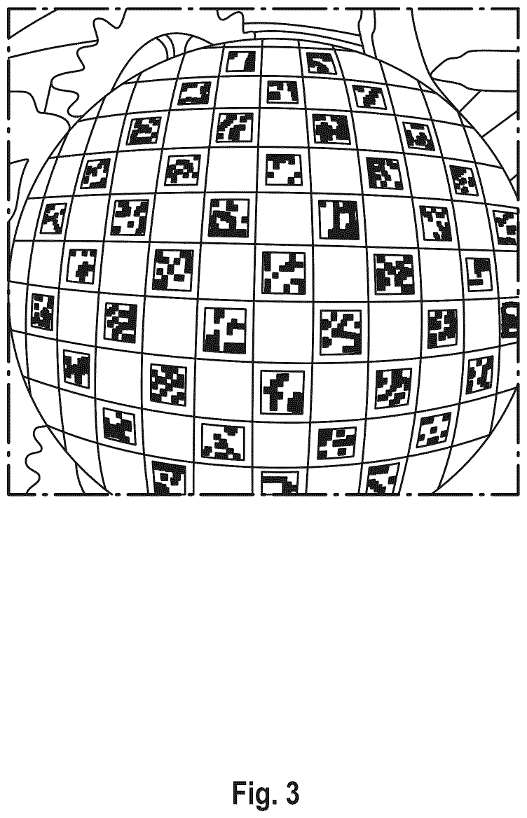

FIG. 3 shows as an example an image of the location marking 36 recorded by the camera 34. The location marking 36 has a chequerboard pattern of register marks, for example in the form of AruCo markers.

A control unit 38 is shown schematically in FIG. 2 and is configured to evaluate images recorded by the camera 34, and, by image processing, from the nature, size, attitude and/or position of the register marks, to determine a position and/or attitude of the end effector 16 relative to the fastening device 30.

Furthermore, a reflection element 40 is arranged on the fastening device 30 and is configured to be detected e.g., by a total station, situated in particular outside the construction robot 10, so that the position and/or attitude of the reflection element 40 and hence the position and/or attitude of the fastening device 30 can be determined.

The control unit 38 may be configured to obtain position and/or attitude data from such a total station and from this, in conjunction with the determined relative position and/or attitude of the end effector 16 relative to the fastening device 30, determine an absolute position and/or attitude of the end effector 16 and hence also, taking into account the situation of the lifting device 22, determine a position and/or attitude of the marker pen 20 relative to the total station, the ceiling 100 and/or another stationary reference system of the construction site.

The control unit 38 may be further configured to control the contact elements 24, i.e., the wheels in this exemplary embodiment, depending on the determined position and/or attitude of the marker pen 20. For example, vibrations or other minor changes in position of the mobile platform 12 may be compensated.

The control unit 38 may preferably be formed as a microcontroller. In particular, it may have a microprocessor and program code stored in a memory unit of the control unit 38 and executable on the microprocessor.

In order to achieve maximum autonomy of the end effector platform 14, the end effector platform 14 may have a further energy source which is independent of the mobile platform 12, for example a rechargeable battery.

The control unit 38, the camera 34 and the location marking 36 thus form a sensor system which is configured to detect a pose of the end effector 16 relative to the mobile platform 12.

The end effector 16 may furthermore have an acceleration sensor 42, which for example measures three-dimensionally (shown merely schematically in FIG. 2). Thus accelerations of the end effector 16 can be measured. By means of the measured accelerations, the determination of the position and/or attitude of the end effector 16 and hence of the marker pen 20, in particular by the control unit 38, can be further improved.

### LIST OF REFERENCE CHARACTERS

10 Construction robot
12 Mobile platform
14 End effector platform
16 End effector
18 Parallel manipulator
20 Marker pen
22 Lifting device
24 Contact element
26 Motor
28 Support arm
30 Fastening device
32 Lighting
34 Camera
36 Location marking
38 Control unit
40 Reflection element
42 Acceleration sensor
100 Ceiling

1.-16. (canceled)

17. A construction robot (10) for carrying out construction work on a construction site object, comprising:
a mobile platform (12);
an end effector (16), wherein the end effector (16) has a tool or a tool fitting and wherein the end effector (16) has a contact element (24) which is configured to contact the construction site object;
a parallel manipulator (18), wherein the end effector (16) and the mobile platform (12) are connected to one another via the parallel manipulator (18); and
a sensor system, wherein a pose of the end effector (16) relative to the mobile platform (12) is detectable by the sensor system.

18. The construction robot (10) as claimed in claim 17, wherein the sensor system comprises an image recording unit.

19. The construction robot (10) as claimed in claim 17, wherein a location marking is disposed on the end effector (16) or on the parallel manipulator (18).

20. The construction robot (10) as claimed in claim 19, wherein the sensor system comprises an image recording unit and wherein the location marking is disposed at least partially in a field of view of the image recording unit.

21. The construction robot (10) as claimed in claim 17, wherein the parallel manipulator (18) is a passive system.

22. The construction robot (10) as claimed in claim 17, wherein the parallel manipulator (18) has at least three degrees of freedom.

23. The construction robot (10) as claimed in claim 17, wherein the parallel manipulator (18) is configured such that, when the end effector (16) deflects slightly out of a rest position relative to the mobile platform (12), the end effector (16) automatically returns to the rest position driven by gravity.

24. The construction robot (10) as claimed in claim 17, wherein the mobile platform (12) is a flying platform.

25. The construction robot (10) as claimed in claim 17, wherein the parallel manipulator (18) is a hexapod.

26. The construction robot (10) as claimed in claim 17, further comprising an acceleration sensor (42), wherein the acceleration sensor (42) is formed on the end effector (16).

27. The construction robot (10) as claimed in claim 17, wherein the end effector (16) or the mobile platform (12) has a position measuring system for determining a pose of the construction robot (10) relative to a construction site, or wherein the end effector (16) or the mobile platform (12) is configured to be detected by the position measuring system for determining a respective position and/or a respective attitude.

28. The construction robot (10) as claimed in claim 27, wherein the position measuring system comprises a laser distance meter or a total station.

29. The construction robot (10) as claimed in claim 17, wherein the contact element (24) has a wheel.

30. The construction robot (10) as claimed in claim 29, wherein the wheel is an omnidirectional wheel.

31. The construction robot (10) as claimed in claim 17, wherein the contact element (24) is driveable by a motor.

32. The construction robot (10) as claimed in claim 17, wherein the parallel manipulator (18) has a reset element and/or a damping element.

33. The construction robot (10) as claimed in claim 17, wherein the tool is a marking tool or a drilling tool or a chiselling tool or a grinding tool or a cutting tool.
